(19) United States
(12) Patent Application Publication
(10) Pub. No.: US 2026/0085887 A1
(43) Pub. Date: Mar. 26, 2026

(54) Waste Heat Recovery and Utilization System and method

(71) Applicant: ZHENGZHOU NON-FERROUS METALS RESEARCH INSTITUTE CO.LTD OF CHALCO, Zhengzhou (CN)

(72) Inventors: Qiang YU, Zhengzhou (CN); Yanan ZHANG, Zhengzhou (CN); Huaijiang WANG, Zhengzhou (CN); Guanghui HOU, Zhengzhou (CN); Xugui ZHANG, Zhengzhou (CN); Yuechao GUAN, Zhengzhou (CN); Guisheng LIANG, Zhengzhou (CN); Kaiai WANG, Zhengzhou (CN); Yanhui LIU, Zhengzhou (CN)

(73) Assignee: ZHENGZHOU NON-FERROUS METALS RESEARCH INSTITUTE CO.LTD OF CHALCO, Zhengzhou (CN)

(21) Appl. No.: 19/403,538

(22) Filed: Nov. 28, 2025

Related U.S. Application Data
(63) Continuation of application No. PCT/CN2024/095887, filed on May 29, 2024.

(30) Foreign Application Priority Data
Jun. 13, 2023 (CN) 202310699230.0

(51) Int. Cl. F27B 3/26; B01D 46/62; C25C 3/20; C25C 3/22

(52) U.S. Cl. CPC F27B 3/266; B01D 46/645; C25C 3/20; C25C 3/22; B01D 2279/00

(57) ABSTRACT

A waste heat recovery and utilization system includes a material waste heat extraction subsystem, a flue gas waste heat recovery subsystem and a control subsystem; the material waste heat extraction subsystem is in communication with the flue gas waste heat recovery subsystem for extracting, by utilizing a flue gas flowing through the material waste heat extraction subsystem, a waste heat from a material with waste heat to be recovered; the flue gas waste heat recovery subsystem is used for recovering a waste heat of flue gas discharged from an aluminum electrolytic cell and a waste heat extracted from the material with waste heat to be recovered; and the control subsystem is used for regulating and controlling operational parameters of the material waste heat extraction subsystem and the flue gas waste heat recovery subsystem during waste heat recovery and utilization.

### CROSS-REFERENCE TO RELATED APPLICATION

This is a continuation of International Application No. PCT/CN2024/095887, filed on May 29, 2024, which claims priority to Chinese Patent Application No. 202310699230.0, filed on Jun. 13, 2023. The disclosures of the above-referenced applications are hereby incorporated by reference in their entireties.

### TECHNICAL FIELD

This disclosure relates to the technical field of aluminum electrolysis, in particular to a waste heat recovery and utilization system, and a waste heat recovery and utilization method.

### BACKGROUND

In the aluminum electrolysis process, there is much waste heat that is not fully utilized. For example, a temperature of flue gas discharged from an aluminum electrolytic cell is generally between 100° C.-140° C., and a flow rate of flue gas from a single cell ranges from 3000 to 10000 m³/h, and a heat carried away by the flue gas accounts for about 30% of a total heat dissipation for an electrolytic cell. For example, a temperature of a hot spent anode butt replaced from the electrolytic cell can be up to 900° C., and a temperature of a spent-anode steel claw is above 500° C., etc. At present, much waste heat generated in the process is often not fully recovered and utilized, resulting in a large amount of heat wasted. 400 kA series electrolytic aluminum plant with a production capacity of 200000 tons is taken as an example, about 300 anode replacements are performed per day, a daily emission of flue gas from electrolytic cells can reach 27 million cubic meters. It can be seen that a large amount of waste heat needs to be developed and utilized. Based on this, how to efficiently recover and utilize the waste heat generated in the aluminum electrolysis process is a technical problem that needs to be solved urgently.

### SUMMARY

An embodiment of the disclosure provides a waste heat recovery and utilization system and method. Based on a technical solution provided by the disclosure, a waste heat of flue gas discharged from an aluminum electrolytic cell can be efficiently recovered and utilized, and a waste heat of material with waste heat to be recovered that has a large amount of waste heat also can be efficiently recovered and utilized, and the waste heat of the flue gas can be used to heat a material to be heated, thereby achieving energy saving and consumption reduction.

Other features and advantages of the disclosure will become apparent from the following detailed description, or may be partially learned through a practice of the disclosure.

According to a first aspect of the disclosure, a waste heat recovery and utilization system is provided, applied to an aluminum electrolysis process, the system comprising: a material waste heat extraction subsystem, a flue gas waste heat recovery subsystem, and a control subsystem; the material waste heat extraction subsystem is in communication with the flue gas waste heat recovery subsystem for extracting a waste heat of a material with waste heat to be recovered by using a flue gas flowing through itself; the flue gas waste heat recovery subsystem is used to recover and utilize waste heat of flue gas discharged from an aluminum electrolytic cell, and waste heat extracted from the material with waste heat to be recovered; and the control subsystem is used to regulate operational parameters of the material waste heat extraction subsystem and the flue gas waste heat recovery subsystem during a waste heat recovery and utilization process.

According to a second aspect of the disclosure, a waste heat recovery and utilization method is provided, the method being executed in a control subsystem, comprising: when it is detected that a material with waste heat to be recovered is placed in the material waste heat extraction subsystem, acquiring an initial flow rate of flue gas in the flue gas waste heat recovery subsystem, and acquiring a heat exchange rate for the material with waste heat to be recovered, the heat exchange rate being the heat extracted per unit time by flue gas flowing through the material waste heat extraction subsystem; determining a target flow rate of flue gas flowing through the material waste heat extraction subsystem based on the heat exchange rate, the heat exchange rate being positively correlated with the target flow rate; and regulating opening degrees of various control valves in the waste heat recovery and utilization system according to the initial flow rate and the target flow rate.

It should be understood that the above general description and the following detailed description are exemplary and explanatory only and do not limit the disclosure.

### BRIEF DESCRIPTION OF DRAWINGS

The drawings, which are incorporated in and constitute a part of this specification, illustrate embodiments consistent with the disclosure and together with the description serve to explain the principles of the disclosure. Obviously, the drawings in the following description are only some embodiments of the disclosure, and for those skilled in the art, other drawings can be obtained from these drawings without creative effort. In the drawings:

FIG. 1 shows a schematic architectural diagram of a waste heat recovery and utilization system according to some embodiments of the disclosure;

FIG. 2 shows a detailed schematic architectural diagram of a waste heat recovery and utilization system according to some embodiments of the disclosure;

FIG. 3 shows a detailed schematic architectural diagram of a material waste heat extraction device according to some embodiments of the disclosure;

FIG. 4 shows a schematic architectural diagram for heating a material to be heated according to some embodiments of the disclosure; and

FIG. 5 shows a schematic flowchart of a waste heat recovery and utilization method according to some embodiments of the disclosure.

In the drawings:
100, flue gas waste heat recovery subsystem; 200, material waste heat extraction subsystem;
300, control subsystem
1, aluminum electrolytic cell; 2, flue gas delivery pipe;
3, flue gas intake pipe; 4, first control valve;
5, flue gas exhaust pipe; 6, material waste heat extraction device;
7, material with waste heat to be recovered; 8, first thermometer;
9, first flow meter; 10, second control valve;
11, third control valve; 12, second flow meter;
13, flue gas heat exchanger; 14, intermediate heat exchanger;
15, water tank; 16, heat consumer;
17, purification unit; 18, first circulation loop;
19, second circulation loop; 20, second thermometer;
603, first filter screen; 604, second filter screen;
605, guardrail; 606, baffle;
607, boss; 608, material tray;
609, load bearing tray; 610, material to be heated;
611, heating box body.

### DETAILED DESCRIPTION

Some embodiments embodying the features and advantages of the disclosure will be described in detail in the following description. It should be understood that the disclosure can have various changes in different embodiments, all of which do not depart from the scope of the disclosure, and the descriptions and drawings therein are essentially for illustrative purposes and not intended to limit the disclosure.

In the description of the disclosure, it should be noted that the orientation or positional relationships indicated by the terms “vertical”, “upper”, “lower”, “horizontal”, etc., are based on the orientation or positional relationships shown in the drawings, and are only for facilitating the description of the disclosure and simplifying the description, rather than indicating or implying that the referred system or element must have a specific orientation, be constructed and operated in a specific orientation, and thus should not be construed as limiting the disclosure.

In the description of the disclosure, it should also be noted that, unless otherwise explicitly specified and defined, the terms “arranged”, “mounted”, “connected”, and “linked” are to be understood broadly, for example, they may be fixed connections, detachable connections, or integral connections; they may be mechanical connections or electrical connections; they may be direct connections or indirect connections through an intermediate medium, and they may be internal connections between two elements. For those skilled in the art, the specific meanings of the above terms in the disclosure can be understood according to specific circumstances.

The following will describe in detail some embodiments of the disclosure with reference to the drawings. In the case of no conflict, the following embodiments and features in the embodiments can be combined with one another.

According to a first aspect of the disclosure, a waste heat recovery and utilization system is provided.

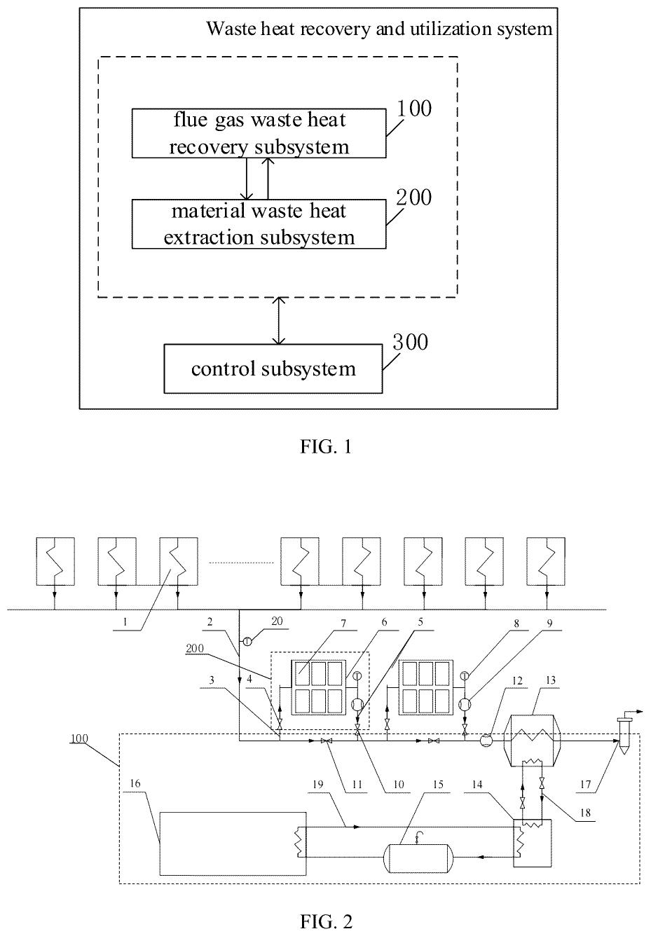

As shown in FIG. 1, a schematic architectural diagram of a waste heat recovery and utilization system according to some embodiments of the disclosure is shown, including a material waste heat extraction subsystem 200, a flue gas waste heat recovery subsystem 100, and a control subsystem 300.

The material waste heat extraction subsystem 200 is in communication with the flue gas waste heat recovery subsystem 100 for extracting waste heat from a material with waste heat to be recovered 7 by using a flue gas flowing through the material waste heat extraction subsystem 200.

It should be noted that the material waste heat extraction subsystem 200 may be in communication with the flue gas waste heat recovery subsystem 100 in a parallel way or series way, preferably in a parallel way, which is not limited in the disclosure.

It should also be noted that the material with waste heat to be recovered 7 from which waste heat can be extracted by the material waste heat extraction subsystem 200 includes, but is not limited to, spent anodes, high-temperature aluminum liquid, a high-temperature liquid waste, a high-temperature solid waste, an electrolyte, and carbon residue, etc.

In some embodiments, by providing the material waste heat extraction subsystem 200 in the waste heat recovery and utilization system, on one hand, heat of materials such as the spent anodes can be extracted through this subsystem, and on the other hand, in the related art, materials such as spent anodes are generally placed in a workshop for natural cooling, and during a cooling process of spent anodes, harmful gases such as fluoride are emitted, causing serious pollution to the environment of the workshop. Therefore, the material waste heat extraction subsystem 200 provided by the disclosure can effectively recover the harmful gases released during natural cooling of spent anodes, and the harmful gases are finally treated by the purification unit 17, thereby improving an environmental protection effect of the workshop.

It should also be noted that one or more material waste heat extraction subsystems 200 connected in parallel may be provided in the waste heat recovery and utilization system, thereby improving an efficiency of waste heat recovery.

In some embodiments, the flue gas waste heat recovery subsystem 100 is used to recover and utilize waste heat of flue gas discharged from an aluminum electrolytic cell 1, and a waste heat extracted from the material with waste heat to be recovered 7.

It can be understood that the flue gas waste heat recovery subsystem 100 can convey the collected flue gas discharged from the aluminum electrolytic cell 1 to the material waste heat extraction subsystem 200, so that the conveyed flue gas, upon flowing through the material waste heat extraction subsystem 200, undergoes heat exchange with the waste heat of the material with waste heat to be recovered 7 placed in the material waste heat extraction subsystem 200, i.e., extracts the waste heat in the material with waste heat to be recovered 7, so that the flue gas flowing out of the material waste heat extraction subsystem 200 contains both the waste heat discharged from the aluminum electrolytic cell 1 and the waste heat from the material with waste heat to be recovered 7.

In some embodiments, a detailed architecture of the waste heat recovery and utilization system of the disclosure is shown in FIG. 2. The material waste heat extraction subsystem 200 may include: a flue gas intake pipe 3, a flue gas exhaust pipe 5, and a material waste heat extraction device 6.

In some embodiments, an inlet of the flue gas intake pipe 3 is in communication with the flue gas waste heat recovery subsystem 100, and an outlet of the flue gas intake pipe 3 is in communication with the material waste heat extraction device 6; an inlet of the flue gas exhaust pipe 5 is in communication with the material waste heat extraction device 6, and an outlet of the flue gas exhaust pipe 5 is in communication with the flue gas waste heat recovery subsystem 100; the material waste heat extraction device 6 is used to place the material with waste heat to be recovered 7.

It should be noted that the material waste heat extraction device 6 in the disclosure is required to be capable of withstanding high temperatures, have a heat insulation structure and a sealed structure, and have an automatic sealing function, thereby improving the extraction efficiency of the waste heat of the material with waste heat to be recovered 7.

As can be seen from FIG. 2, there are two material waste heat extraction subsystems 200, which are in communication with the flue gas waste heat recovery subsystem 100 in a parallel way.

As can be seen from FIG. 2, a flue gas collected by the flue gas waste heat recovery subsystem 100 from the aluminum electrolytic cell 1 can be conveyed to the material waste heat extraction device 6 through the flue gas intake pipe 3, so that the flue gas flows through the material waste heat extraction device 6 and can extract the waste heat of a placed material with waste heat to be recovered 7, and then the flue gas flows back into the flue gas waste heat recovery subsystem 100 through the flue gas exhaust pipe 5. Thus the flue gas waste heat recovery subsystem 100 can both recover and utilize the waste heat of the flue gas discharged from the aluminum electrolytic cell 1 and the waste heat extracted from the material with waste heat to be recovered 7.

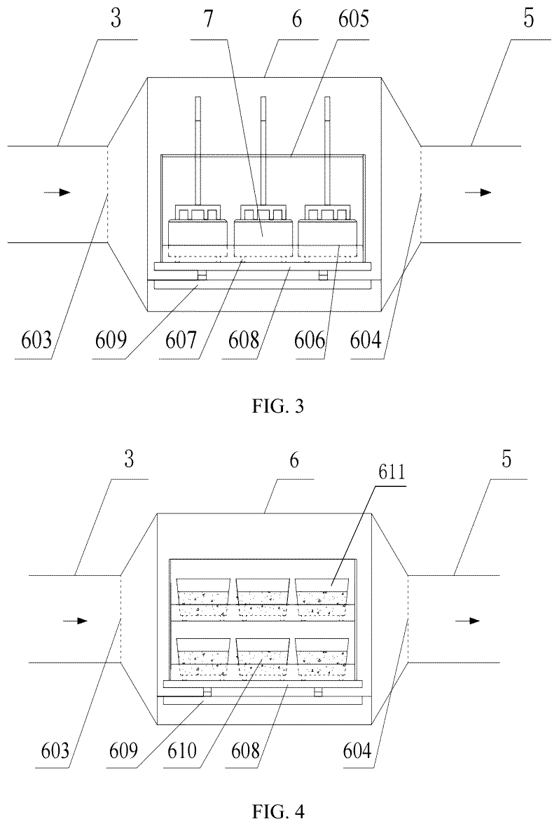

In some embodiments, the specific design of the material waste heat extraction device 6 in the material waste heat extraction subsystem 200 can be as shown in FIG. 3.

As shown in FIG. 3, a detailed schematic architectural diagram of a material waste heat extraction device according to some embodiments of the disclosure is shown.

According to some embodiments of the disclosure, the material waste heat extraction device may include: a load-bearing tray 609, arranged in the material waste heat extraction device 6, for carrying the material with waste heat to be recovered 7; a telescoping mechanism, arranged on a lower side of the load-bearing tray 609, for moving the material with waste heat to be recovered 7 into or out of the material waste heat extraction device 6; a material tray 608, arranged above the load-bearing tray 609, for placing the material with waste heat to be recovered 7; a boss 607, arranged on the material tray 608, for isolating a lower surface of the material with waste heat to be recovered 7 and an upper surface of the material tray 608; and a protection device, arranged in the material waste heat extraction device 6, for protecting the material with waste heat to be recovered 7.

In some embodiments, the telescoping mechanism may adopt conventional techniques such as a chain type, hydraulic type, or pneumatic cylinder type, and have functions of automatic lifting or horizontal telescoping, so that the material with waste heat to be recovered 7 can be automatically moved from the outside into the material waste heat extraction device 6 or moved out from the material waste heat extraction device 6 to the outside.

In some embodiments, the material tray 608 and the boss 607 can be moved out of or into the material waste heat extraction device 6 together with the material with waste heat to be recovered 7. It can be understood that the boss 607 in the material waste heat extraction device 6 is designed to enable the flue gas to fully contact the material with waste heat to be recovered 7, thereby facilitating a full extraction of the waste heat of the material with waste heat to be recovered 7 and improving a recovery efficiency of the waste heat.

In some embodiments, the protection device includes a guardrail 605 and a baffle 606 as shown in FIG. 3, thereby preventing the material with waste heat to be recovered 7 or the material to be heated 610 from tipping over in the material waste heat extraction device 6. In some embodiments, the protection device can also be designed according to actual conditions, which is not specifically limited herein in the disclosure.

In some embodiments, the material waste heat extraction subsystem 200 is also used to heat a material to be heated 610 by using a flue gas flowing through the material waste heat extraction subsystem 200.

It should be noted that the material to be heated 610 includes, but is not limited to, new anodes, fresh alumina, aluminum fluoride, crushed material, and the like added to the aluminum electrolytic cell 1.

It can be understood that in an aluminum electrolysis process, a new anode, before used, may need to be preheated. Therefore, if the new anode needs to be preheated, placing the new anode in the material waste heat extraction device 6 of the material waste heat extraction subsystem 200 designed in the disclosure may allow the flue gas flowing in from the flue gas waste heat recovery subsystem 100 to fully and efficiently preheat the new anode, improving a recovery and utilization rate of the flue gas waste heat. In some embodiments, a new anode can be quickly preheated to above 100° C. based on a temperature of 120° C. of discharged flue gas of aluminum electrolytic cell 1.

It should also be noted that, in some embodiments, a specific architectural design of the material waste heat extraction device 6 for heating the material to be heated 610 may be as shown in FIG. 4.

As shown in FIG. 4, a schematic architectural diagram for heating a material to be heated according to some embodiments of the disclosure is shown.

It can be understood that the material waste heat extraction device 6 for heating the material to be heated 610 is basically the same as the material waste heat extraction device 6 for extracting waste heat of the material with waste heat to be recovered 7, except that a heating box body 611 is added on the material tray 608 to accommodate the material to be heated 610.

It should be noted that the heating box body 611 is a box body made of high thermal conductivity metal, such as iron, aluminum, copper, etc., so that the heating box body 611 can contain materials added to the aluminum electrolytic cell 1 such as fresh alumina, aluminum fluoride, and crushed material. In some embodiments, a temperature of flue gas discharged from aluminum electrolytic cell 1 is generally 120° C., and the material to be heated 610 can be quickly preheated to above 100° C.

It should also be noted that the heating box body 611 may not be provided in the material waste heat extraction device 6 according to actual needs; for example, if a new anode is heated, the heating box body 611 may not be needed.

In some embodiments, as shown in FIG. 3, the material waste heat extraction subsystem 200 further includes: a first filter screen 603, arranged at an outlet of the flue gas intake pipe 3, or may also arranged at an inlet of the flue gas intake pipe 3; and a second filter screen 604, arranged at an inlet of the flue gas exhaust pipe 5.

It can be understood that, with the filter screen provided in the material waste heat extraction subsystem 200, on one hand, the flue gas flowing into the material waste heat extraction device 6 can be filtered to prevent a residue from entering the material waste heat extraction device 6; on the other hand, the flue gas flowing out from the material waste heat extraction device 6 can be filtered to prevent the residue from the material with waste heat to be recovered 7 from entering the flue gas waste heat recovery subsystem 100 and affecting an operation of the flue gas waste heat recovery subsystem 100.

As shown in FIG. 2, in some embodiments, the material waste heat extraction subsystem 200 may further include: a first control valve 4, arranged on the flue gas intake pipe 3, for regulating a flow rate of flue gas flowing into the material waste heat extraction device 6; a second control valve 10, arranged on the flue gas exhaust pipe 5, for regulating a flow rate of flue gas flowing out from the material waste heat extraction device 6; a first temperature meter 8, arranged on the flue gas exhaust pipe 5, for measuring a temperature of the flue gas flowing out from the material waste heat extraction device 6; and a first flow meter 9, arranged on the flue gas exhaust pipe 5, for measuring a flow rate of the flue gas flowing out from the material waste heat extraction device 6.

In some embodiments, the first control valve 4 and the second control valve 10 may be electric control valves or other valves with control functions, which are not limited herein in the disclosure.

In some embodiments, the first temperature meter 8 may be a thermocouple or other components with temperature measurement functions, which are not limited herein in the disclosure.

As shown in FIG. 2, in some embodiments, the flue gas waste heat recovery subsystem 100 may include a waste heat treatment unit, a flue gas delivery pipe 2, a second flow meter 12, a second temperature meter 20, and a third control valve 11.

In some embodiments, the flue gas delivery pipe 2 is used to convey a flue gas discharged from the aluminum electrolytic cell 1 to the waste heat treatment unit; the waste heat treatment unit is used to convert a waste heat of the flue gas discharged from the aluminum electrolytic cell 1 and waste heat extracted from the material with waste heat to be recovered 7 into a utilizable heat; the second flow meter 12 is arranged near an outlet of the flue gas delivery pipe 2 for measuring a flow rate of flue gas in the flue gas delivery pipe 2; the second temperature meter 20 is arranged on the flue gas delivery pipe 2 for measuring a temperature of the flue gas in the flue gas delivery pipe 2; the third control valve 11 is arranged on the flue gas delivery pipe 2 for regulating a flow rate of flue gas flowing through the flue gas delivery pipe 2.

It should be noted that, in some embodiments, one or more third control valves 11 may be provided on the flue gas delivery pipe 2, and may be an electrically controlled valve or other valves with control functions, which are not specifically limited herein in the disclosure.

It should also be noted that the second flow meter 12 is designed to monitor a flow rate of flue gas flowing into the waste heat treatment unit, so the second flow meter 12 needs to be arranged near the outlet of the flue gas delivery pipe 2.

It should also be noted that, in some embodiments, positions of various aluminum electrolytic cells 1 are in parallel, and thus discharged flue gases can each be discharged into the flue gas delivery pipe 2 of the flue gas waste heat recovery subsystem 100. It can be understood that the inlet of the flue gas delivery pipe 2 may be one or more.

It should also be noted that the second temperature meter 20 may be a thermocouple or other components with temperature measurement functions, which are not limited herein in the disclosure.

In some embodiments, the waste heat treatment unit includes: a flue gas heat exchanger 13, in communication with the outlet of the flue gas delivery pipe 2, for converting the recovered waste heat into hot water or steam; a purification unit 17, in communication with the flue gas heat exchanger 13, for treating harmful substances input from the flue gas heat exchanger 13; an intermediate heat exchanger 14, in communication with the flue gas heat exchanger 13 through a first circulation loop 18, and in communication with a heat consumer 16 through a second circulation loop 19, for regulating and controlling, and distributing the heat input from the flue gas heat exchanger 13; and a water tank 15, arranged on the second circulation loop 19, for stabilizing the heat provided to the heat consumer 16.

It can be understood that, in the disclosure, by designing the purification unit 17, the flue gas treated by the waste heat recovery and utilization system can be purified before being discharged into the atmosphere, which is beneficial to improving the production workshop environment and achieving green production processes.

Refer to FIG. 1, the waste heat recovery and utilization system further includes a control subsystem 300, which is connected to the material waste heat extraction subsystem 200 and the flue gas waste heat recovery subsystem 100, respectively, for regulating and controlling operational parameters of the material waste heat extraction subsystem 200 and the flue gas waste heat recovery subsystem 100 during a process of waste heat recovery and utilization.

It can be understood that the control subsystem 300 can perform a logical control on the waste heat recovery and utilization system, the logical control includes but not limited to: real-time acquiring and monitoring flow rates measured by various flow meters; regulating opening degrees of various control valves; real-time acquiring and monitoring temperatures measured by various temperature meters; controlling, turning on and turning off the material waste heat extraction device 6; controlling an operation of the telescoping mechanism in the material waste heat extraction device 6; and controlling a turning on and turning off of waste heat recovery by the waste heat recovery and utilization system, etc.

For the specific execution logic of the control subsystem 300, references may be made to the following method embodiments of the second aspect of the disclosure, which will not be repeated herein in the disclosure.

According to a second aspect of the disclosure, a waste heat recovery and utilization method is provided, and is executed in the control subsystem 300.

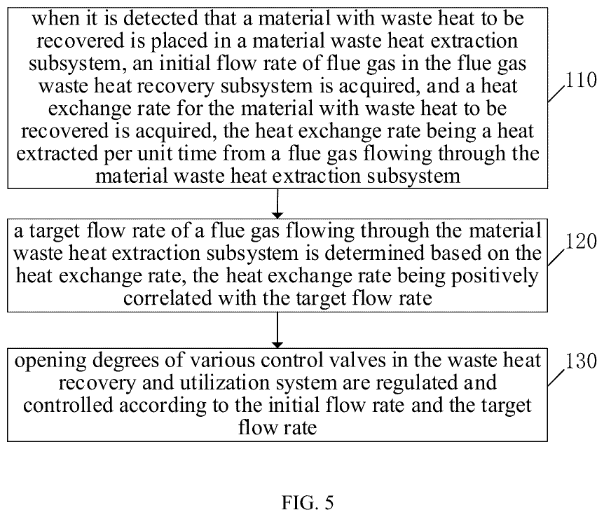

As shown in FIG. 5, a schematic flowchart of a waste heat recovery and utilization method according to some embodiments of the disclosure is shown. The waste heat recovery and utilization method according to some embodiments of the disclosure may include steps S110 to S130.

In step S110, when it is detected that a material with waste heat to be recovered is placed in a material waste heat extraction subsystem, an initial flow rate of flue gas in the flue gas waste heat recovery subsystem is acquired, and a heat exchange rate for the material with waste heat to be recovered is acquired, the heat exchange rate being a heat extracted per unit time from a flue gas flowing through the material waste heat extraction subsystem.

In some embodiments, the initial flow rate can be obtained by the second flow meter 12 designed above.

It should be noted that if the waste heat recovery and utilization system does not need to recover the waste heat of the material with waste heat to be recovered 7, the material waste heat extraction subsystem 200 is in a turn-off state. The turn-off state means that no flue gas exchange is performed between the material waste heat extraction subsystem 200 and the flue gas waste heat recovery subsystem 100. In some embodiments, for example, by turning off the first control valve 4 on the flue gas intake pipe 3 and the second control valve 10 on the flue gas exhaust pipe 5, no exchange of flue gas between the material waste heat extraction subsystem 200 and the flue gas waste heat recovery subsystem 100 can be achieved.

It should also be noted that as long as the aluminum electrolytic cell 1 is in an operational state, the flue gas waste heat recovery subsystem 100 can be in a turn-on state, thereby efficiently recovering and utilizing the waste heat of flue gas. Therefore, it can be understood that when no material with waste heat to be recovered 7 is placed in the material waste heat extraction subsystem 200, the corresponding first control valve 4 and second control valve 10 are in a turn-off state.

It should also be noted that, in the disclosure, to ensure that the waste heat treatment unit in the flue gas waste heat recovery subsystem 100 can continuously and stably process the recovered waste heat, it is required to ensure a stable flow rate of the flue gas input to the flue gas heat exchanger of the waste heat treatment unit.

Therefore, if the flue gas waste heat recovery subsystem 100 is in operation and needs to use the material waste heat extraction subsystem 200 to recover the waste heat existing in the material with waste heat to be recovered 7, it is required to ensure that after the material waste heat extraction subsystem 200 is started, the flow rate of the flue gas flowing into the flue gas heat exchanger of the waste heat treatment unit remains unchanged, i.e., after the material waste heat extraction subsystem 200 is started, the flow rate of the flue gas flowing into the flue gas heat exchanger of the waste heat treatment unit still needs to be maintained at the initial flow rate.

In some embodiments, the specific implementation manner of acquiring the heat exchange rate for the material with waste heat to be recovered 7 may be manually set according to the material properties of the material with waste heat to be recovered 7, workshop process requirements, etc., for example, the heat exchange rate for the material with waste heat to be recovered 7 is set to 6 kWh/min, meaning that 6 kWh of heat needs to be extracted from the material with waste heat to be recovered 7 within 1 minute.

In some embodiments, the specific implementation manner of acquiring the heat exchange rate for the material with waste heat to be recovered 7 may be performed according to the following steps S111 to S113.

In step S111, an initial temperature of the flue gas in the flue gas waste heat recovery subsystem, an initial residual heat of the material with waste heat to be recovered itself, and a preset duration for performing waste heat extraction on the material with waste heat to be recovered are acquired.

In some embodiments, the initial temperature can be obtained by the second temperature meter 20 designed above. It can be understood that when the material waste heat extraction subsystem 200 is not yet running, the detected initial temperature represents the temperature of the flue gas in the flue gas delivery pipe 2.

It should be noted that the initial residual heat of the material with waste heat to be recovered 7 itself is related to the aluminum electrolysis process and the properties of the material with waste heat to be recovered 7 itself, and generally can be obtained based on empirical values. In some embodiments, a temperature of a spent anode butt replaced from the aluminum electrolytic cell 1 is as high as about 900° C., and a temperature of a spent-anode steel claw is above 500° C. Therefore, based on the above temperature, the initial residual heat existing in the spent anode butt and spent-anode steel claw from which waste heat needs to be extracted can be obtained.

It should also be noted that the preset duration for performing waste heat extraction can be determined according to the production process of aluminum electrolysis. In some embodiments, a single cell is provided with 48 anodes, an anode replacement cycle is 30 days, and the number of anode replacements per day for a whole plant is 288, and the number of anode replacements per hour is 12. If the material waste heat extraction subsystem 200 can accommodate 6 spent anodes at a time, the preset duration can be set as 0.5 h.

In step S112, a residual heat of the material with waste heat to be recovered at a temperature equal to the initial temperature is determined as a target residual heat.

It should be noted that only when a temperature of the flue gas discharged from the aluminum electrolytic cell 1 is lower than a temperature of the material with waste heat to be recovered 7, can the flue gas flowing through be used to extract the waste heat of the material with waste heat to be recovered 7. Therefore, when the material with waste heat to be recovered 7 is placed in the material waste heat extraction subsystem 200 for waste heat extraction, the temperature of the material with waste heat to be recovered 7 will gradually decrease as a heat thereof is gradually transferred to the flue gas flowing through.

Therefore, during the waste heat extraction process, when a temperature of the material with waste heat to be recovered 7 gradually decreases to reach the initial temperature, it is indicated that a waste heat extraction process for the material with waste heat to be recovered 7 has been completed. Therefore, based on an initial temperature of the flue gas, a residual heat still remaining in the material with waste heat to be recovered 7 when a waste heat extraction is completed can be determined, i.e., the target residual heat.

In step S113, the heat exchange rate is determined based on the initial residual heat, the target residual heat, and the preset duration.

In some embodiments, the heat exchange rate can be calculated according to the following formula:

Heat exchange rate=(initial residual heat-target residual heat)/preset duration

Refer to FIG. 5, in step S120, a target flow rate of a flue gas flowing through the material waste heat extraction subsystem is determined based on the heat exchange rate, the heat exchange rate being positively correlated with the target flow rate.

It can be understood that if a higher heat exchange rate is required for extracting the waste heat of the material with waste heat to be recovered 7, then a larger flow rate of flue gas flowing through the material waste heat extraction device 6 is needed, so that more waste heat can be extracted per unit time.

In some embodiments, correspondence relationship between the heat exchange rate and the target flow rate can be determined by conducting experiments. The obtained correspondence relationship is: target flow rate=A×heat exchange rate, where A is a conversion coefficient determined through experiments, so that the target flow rate for the material with waste heat to be recovered 7 can be determined based on the obtained heat exchange rate.

Refer to FIG. 5, in step S130, opening degrees of various control valves in the waste heat recovery and utilization system are regulated and controlled according to the initial flow rate and the target flow rate.

It should be noted that during the operation of the material waste heat extraction subsystem 200, it is required to ensure that the flow rate of flue gas at a position of the second flow meter 12 as shown in FIG. 2 is stable and unchanged. Then, when the material waste heat extraction subsystem 200 is started and operated, it is required to regulate the opening degrees of the first control valve 4 and the second control valve 10 in the material waste heat extraction subsystem 200 and the third control valve 11 in the flue gas waste heat recovery subsystem 100, so that the flow rate of the flue gas at the position of the second flow meter 12 remains at the initial flow rate.

It should also be noted that after the target flow rate flowing through the material waste heat extraction device 6 is determined, the opening degrees of the first control valve 4 and the second control valve 10 can be determined. The flow rate of the flue gas flowing through the third control valve 11 can also be determined based on the target flow rate and the initial flow rate, so that the opening degree of the third control valve 11 can be determined.

In some embodiments, correspondence relationships among the opening degrees of various control valves and the flue gas flow rates can be determined through experiments, thereby achieving precise regulation and controlling of the opening degrees of various control valves.

It can be understood that, according to the technical solutions of some embodiments of the disclosure, stable operation of the waste heat recovery and utilization system during the waste heat recovery process for the material with waste heat to be recovered 7 can be achieved, to be capable of improving a recovery efficiency and enabling a precise recovery of the waste heat of the material with waste heat to be recovered 7.

In some embodiments, how to judge whether the waste heat extraction for the material with waste heat to be recovered 7 is completed can be implemented in the following two ways.

A first implementation of monitoring time: when the preset duration is reached, the waste heat extraction for the material with waste heat to be recovered 7 is stopped.

According to other embodiments of the disclosure, the waste heat recovery and utilization method may include the following steps S100 to S200.

In step S100, a flue gas temperature of a flue gas flowing out from the material waste heat extraction subsystem is monitored in real time during a process of a waste heat extraction for the material with waste heat to be recovered.

In some embodiments, with a temperature measured by the first temperature meter 8 arranged on the flue gas exhaust pipe 5, the flue gas temperature of the flue gas flowing out from the material waste heat extraction subsystem 200 can be monitored in real time. It can be understood that the flue gas temperature of the flue gas flowing out from the material waste heat extraction subsystem 200 is equal to the temperature of the flue gas flowing out from the material waste heat extraction device 6.

In step S200, when it is monitored that the flue gas temperature is less than or equal to the initial temperature, the waste heat extraction for the material with waste heat to be recovered is stopped.

It can be understood that when it is monitored that the flue gas temperature is less than or equal to the initial temperature, it means that the temperature of the material with waste heat to be recovered 7 placed in the material waste heat extraction subsystem 200 has become less than or equal to the initial temperature, and thus it is represented that the waste heat extraction for the material with waste heat to be recovered 7 has been completed and needs to be stopped.

In some embodiments, stopping the waste heat extraction for the material with waste heat to be recovered 7 may be performed according to the following steps S210 to S220.

In step S210, the first control valve and the second control valve are turned off, and the third control valve is fully turned on.

In step S220, when it is monitored that the flow rate measured by the first flow meter is zero, the telescoping mechanism is controlled to move the material with waste heat to be recovered out from the material waste heat extraction device.

In some embodiments, stopping the waste heat extraction for the material with waste heat to be recovered 7 can be designed according to actual conditions, which is not limited herein in the disclosure.

To enable those skilled in the art to better understand the beneficial effects brought by the technical solution of the disclosure, the waste heat recovery and utilization system and method of the disclosure will be illustrated below with reference to Example 1.

### Example 1

In a certain aluminum plant, 180 cells of 400 kA electrolytic cells are operated, with a flue gas temperature of 120° C. and an initial flow rate of 6000 m³/h; a single cell is provided with 48 anodes, with an anode replacement cycle of 30 days; the number of anode replacements per day for the whole plant is 288, and the number of anode replacements per hour is 12. According to an initial flue gas condition, various operational parameters of the waste heat recovery and utilization system are set, and an operating cycle for the material waste heat extraction subsystem 200 to extract heat is controlled as 0.5 h. Each time, 6 spent anodes are installed, and a recovered waste heat from the spent-anode steel claws is about 30 kWh, so the recovered waste heat from spent anodes per hour is 360 kWh. Based on an electricity price of 0.45 CNY, an annual economic benefit of this technology is 1.42 million CNY.

In the technical solutions provided by some embodiments of the disclosure, the designed waste heat recovery and utilization system, applied to an aluminum electrolysis process, includes: a material waste heat extraction subsystem 200, in communication with a flue gas waste heat recovery subsystem 100 for extracting a waste heat of a material with waste heat to be recovered 7 by using flue gas flowing through the material waste heat extraction subsystem 200; a flue gas waste heat recovery subsystem 100, for recovering and utilizing a waste heat of flue gas discharged from an aluminum electrolytic cell 1, and a waste heat extracted from the material with waste heat to be recovered 7; and a control subsystem 300 for regulating operational parameters of the material waste heat extraction subsystem 200 and the flue gas waste heat recovery subsystem 100 during a process of waste heat recovery and utilization.

According to the technical solutions of some embodiments of the disclosure, at least the following technical effects can be achieved.
1. By designing the flue gas waste heat recovery subsystem 100, the waste heat of the flue gas generated during the operation of the aluminum electrolytic cell 1 can be fully and efficiently recovered and utilized, thereby achieving energy saving and emission reduction;
2. By designing the material waste heat extraction subsystem 200, the waste heat of waste heat material to be recovered 7 that have a large amount of waste heat, such as spent anodes, high-temperature aluminum liquid, and high-temperature solid waste, can be efficiently recovered and utilized, so that a large amount of undeveloped and unused waste heat existing in the aluminum electrolysis process can be efficiently recovered;
3. Through the provided material waste heat extraction subsystem 200, the waste heat of the flue gas discharged from the material to be heated 610 can be efficiently recovered and utilized, enabling multi-dimensional utilization of the waste heat of the flue gas;
4. By providing a telescoping mechanism in the material waste heat extraction subsystem 200 and providing the control subsystem 300, a process of extracting waste heat from the material with waste heat to be recovered 7 is fully automated, thereby improving operational safety;
5. Through the technical solution of the waste heat recovery and utilization method of the disclosure, a stable operation during a process of waste heat recovery and utilization can be ensured, thereby improving recovery efficiency;
6. By designing the purification unit 17 in the system, the environmental protection effect can be improved.

Technical solutions according to some embodiments of the disclosure can be applied to the aluminum electrolytic process. The designed waste heat recovery and utilization system includes a material waste heat extraction subsystem in communication with a flue gas waste heat recovery subsystem for extracting a waste heat of a material with waste heat to be recovered by using flue gas flowing through the material waste heat extraction subsystem; further includes a flue gas waste heat recovery subsystem for recovering and utilizing a waste heat of flue gas discharged from an aluminum electrolytic cell and waste heat extracted from the material with waste heat to be recovered; and further includes a control subsystem for regulating and controlling operational parameters of the material waste heat extraction subsystem and the flue gas waste heat recovery subsystem during a process of waste heat recovery and utilization. It can be seen that in the disclosure, by designing the flue gas waste heat recovery subsystem, the waste heat of the flue gas discharged from the aluminum electrolytic cell can be efficiently recovered and utilized, and by designing the material waste heat extraction subsystem, the waste heat of waste heat materials to be recovered that have a large amount of waste heat can be efficiently recovered and utilized. Thus, a technical solution of the disclosure can be used for recovering and utilizing the waste heat of materials that have a large amount of waste heat, such as spent anodes, high-temperature aluminum liquid, and high-temperature solid waste, etc. Compared with the current process situation, a large amount of undeveloped and unused waste heat can be efficiently recovered and utilized, thereby achieving energy saving and emission reduction, and improving the environmental protection effect.

The above descriptions are only embodiments of the disclosure and are not intended to limit the disclosure. For those skilled in the art, the disclosure may have various modifications and changes. Any modifications, equivalent replacements, improvements, etc., made within the spirit and principles of the disclosure shall be included within the scope of the claims of the disclosure.

What is claimed is:

1. A waste heat recovery and utilization system, applied to an aluminum electrolysis process, comprising: a material waste heat extraction subsystem, a flue gas waste heat recovery subsystem, and a control subsystem;
the material waste heat extraction subsystem is in communication with the flue gas waste heat recovery subsystem for extracting a waste heat of a material with waste heat to be recovered by using a flue gas flowing through the material waste heat extraction subsystem;
the flue gas waste heat recovery subsystem is used to recover and utilize a waste heat of a flue gas discharged from an aluminum electrolytic cell, and a waste heat extracted from the material with waste heat to be recovered; and
the control subsystem is used to regulate and control operational parameters of the material waste heat extraction subsystem and the flue gas waste heat recovery subsystem during a process of waste heat recovery and utilization.

2. The system according to claim 1, wherein the material waste heat extraction subsystem is further used to heat a material to be heated by using the flue gas flowing through the material waste heat extraction subsystem.

3. The system according to claim 1, wherein the material waste heat extraction subsystem comprises: a flue gas intake pipe, a flue gas exhaust pipe, and a material waste heat extraction device;
an inlet of the flue gas intake pipe is in communication with the flue gas waste heat recovery subsystem, and an outlet of the flue gas intake pipe is in communication with the material waste heat extraction device;
an inlet of the flue gas exhaust pipe is in communication with the material waste heat extraction device, and an outlet of the flue gas exhaust pipe is in communication with the flue gas waste heat recovery subsystem; and
the material waste heat extraction device is used to place the material with waste heat to be recovered.

4. The system according to claim 3, wherein the material waste heat extraction subsystem further comprises:
a first filter screen, arranged at an inlet or outlet of the flue gas intake pipe;
a second filter screen, arranged at an inlet of the flue gas exhaust pipe;
a first control valve, arranged on the flue gas intake pipe, for regulating a flow rate of a flue gas flowing into the material waste heat extraction device;
a second control valve, arranged on the flue gas exhaust pipe, for regulating a flow rate of a flue gas flowing out from the material waste heat extraction device;
a first temperature meter, arranged on the flue gas exhaust pipe, for measuring a temperature of the flue gas flowing out from the material waste heat extraction device; and
a first flow meter, arranged on the flue gas exhaust pipe, for measuring a flow rate of the flue gas flowing out from the material waste heat extraction device.

5. The system according to claim 3, wherein the material waste heat extraction device is a sealed structure, and comprises:
a load-bearing tray, arranged in the material waste heat extraction device, for carrying the material with waste heat to be recovered;
a telescoping mechanism, arranged below the load-bearing tray, for moving the material with waste heat to be recovered into or out from the material waste heat extraction device;
a material tray, arranged above the load-bearing tray, for placing the material with waste heat to be recovered;
a boss, arranged on the material tray, for isolating a lower surface of the material with waste heat to be recovered from an upper surface of the material tray; and
a protection device, arranged in the material waste heat extraction device, for protecting the material with waste heat to be recovered.

6. The system according to claim 1, wherein the flue gas waste heat recovery subsystem comprises a waste heat treatment unit, a flue gas delivery pipe, a second flow meter, a second temperature meter, and a third control valve;
the flue gas delivery pipe is used to convey the flue gas discharged from the aluminum electrolytic cell to the waste heat treatment unit;
the waste heat treatment unit is used to convert the waste heat of the flue gas discharged from the aluminum electrolytic cell and the waste heat extracted from the material with waste heat to be recovered into a utilizable heat;
the second flow meter is arranged near an outlet of the flue gas delivery pipe for measuring a flow rate of a flue gas in the flue gas delivery pipe;
the second temperature meter is arranged on the flue gas delivery pipe for measuring a temperature of the flue gas in the flue gas delivery pipe; and
the third control valve is arranged on the flue gas delivery pipe for regulating a flow rate of a flue gas flowing through the flue gas delivery pipe.

7. The system according to claim 6, wherein the waste heat treatment unit comprises:
a flue gas heat exchanger, in communication with the outlet of the flue gas delivery pipe, for converting a recovered waste heat into hot water or steam;
a purification unit, connected to the flue gas heat exchanger, for treating harmful substances input from the flue gas heat exchanger;
an intermediate heat exchanger, in communication with the flue gas heat exchanger through a first circulation loop, and in communication with a heat consumer through a second circulation loop, for regulating and controlling, and distributing a heat input from the flue gas heat exchanger; and
a water tank, arranged on the second circulation loop, for stabilizing a heat provided to the heat consumer.

8. A waste heat recovery and utilization method, executed in the control subsystem of the waste heat recovery and utilization system according to claim 1, comprising:
acquiring, when it is detected that a material with waste heat to be recovered is placed in the material waste heat extraction subsystem, an initial flow rate of a flue gas in the flue gas waste heat recovery subsystem, and a heat exchange rate for the material with waste heat to be recovered, the heat exchange rate being a heat extracted per unit time from a flue gas flowing through the material waste heat extraction subsystem;
determining a target flow rate of the flue gas flowing through the material waste heat extraction subsystem based on the heat exchange rate, the heat exchange rate being positively correlated with the target flow rate; and
regulating and controlling opening degrees of various control valves in the waste heat recovery and utilization system according to the initial flow rate and the target flow rate.

9. The method according to claim 8, wherein the acquiring the heat exchange rate for the material with waste heat to be recovered comprises:
acquiring an initial temperature of the flue gas in the flue gas waste heat recovery subsystem, an initial residual heat of the material with waste heat to be recovered itself, and a preset duration for performing a waste heat extraction on the material with waste heat to be recovered;
determining a residual heat, of the material with waste heat to be recovered at a temperature equal to the initial temperature, as a target residual heat; and
determining the heat exchange rate based on the initial residual heat, the target residual heat, and the preset duration.

10. The method according to claim 9, further comprising:
monitoring a flue gas temperature of a flue gas flowing out from the material waste heat extraction subsystem in real time during a process of the waste heat extraction for the material with waste heat to be recovered; and
stopping the waste heat extraction for the material with waste heat to be recovered when it is monitored that the flue gas temperature is less than or equal to the initial temperature.
